(19) United States
(12) Patent Application Publication
(10) Pub. No.: US 2005/0076253 A1
(43) Pub. Date: Apr. 7, 2005

(54) METHOD OF URL-BASED POWER MANAGEMENT AND ASSOCIATED WEB BROWSING DEVICE

(76) Inventor: De-Jen Lu, Taipei Hsien (TW)

Correspondence Address: NORTH AMERICA INTERNATIONAL PATENT OFFICE (NAIPC), P.O. BOX 506, MERRIFIELD, VA, 22116, US

(21) Appl. No.: 10/605,515

(22) Filed: Oct. 5, 2003

(51) Int. Cl. G06F 1/32; G06F 1/26

(52) U.S. Cl. 713/320

(57) ABSTRACT

A web browsing device includes a CPU having a plurality of frequency or voltage settings, a storage device storing a prediction table listing predicted frequency or voltage settings of the CPU for a plurality of web pages organized by universal resource locator (URL), and a power manager. The power manager sets the frequency or voltage setting of the CPU when opening a web page. If the URL of the web page is listed in the prediction table, the power manager sets the frequency or voltage of the CPU to the predicted frequency or voltage setting for the web page listed in the prediction table. If the URL of the web page is not listed in the prediction table, the power manager sets the frequency or voltage setting of the CPU to a default value. The power manager tracks the CPU workload while processing the web page, calculates an optimal frequency or voltage setting for the CPU based on the web page workload, and updates the prediction table to reflect the optimal frequency or voltage setting.

### BACKGROUND OF INVENTION

1. Field of the Invention

The invention relates to managing the power consumption of a web browsing device, and more particularly, to a uniform/universal resource locator (URL) based power management method for managing the power consumption of a portable device.

2. Description of the Prior Art

The Internet contains a wealth of information available in the form of web pages at various websites. Websites contain information on almost any topic and are accessible on a worldwide basis from any computer connected to Internet. In order to view websites, also known as browsing, one must use a web-browsing device. Common web browsing devices include: desktop computers, set-top boxes, laptop computers, notebooks, personal digital assistants (PDAs), and even cell phones.

In todays modern information-oriented society, people increasingly desire access to information from any location. For this reason, portable electronic devices have become very popular. Although, battery technology has advanced and batteries now last longer than ever before, portable electronic devices remain limited by a finite usage time period before the batteries die and need to be recharged or replaced. For this reason, power efficiency is of primary concern when designing a portable electronic device.

One of the major power consuming components in a portable electronic device is the central processing unit (CPU). The power consumption of a transistor is directly proportional to the operating frequency and voltage of the transistor, and CPUs typically contain tens of millions of transistors running at frequencies up to multiple gigahertz. This illustrates a trade off between performance and power conservation with portable electronics. Higher CPU frequencies mean higher performance but at the expense of increased power consumption. Increased power consumption means the batteries of the device do not last as long and need to be recharged or replaced more frequently, greatly inconveniencing the user.

To address this problem, CPU manufactures have designed various power saving modes in microprocessor chipsets designed specifically for portable devices to conserve battery power. One common power saving technique is called Dynamic Voltage Scaling (DVS), which allows software to dynamically vary the operating frequency and the voltage of the microprocessor. Each operating voltage corresponds to a range of frequencies. The higher the core voltage, the higher the maximum core frequency of the CPU and vice versa. An example of a microprocessor implementing DVS technology is the Intel mobile Pentium® processor.

FIG. 1 shows a table 100 of CPU voltages and frequencies for the Mobile Pentium®III processor using Intel SpeedStep® Technology. The power consumption of the Mobile Pentium®III processor ranges from 4.5W, at lowest performance, to 34.0W, at highest performance. In other words, 7.5 times increased power consumption at the highest performance settings. Proper control of the frequency or voltage settings of a microprocessor using DVS is essential to take advantage of the reduced power consumption without negatively affecting the user.

Having a variable CPU frequency and voltage allows the device to be both battery conserving during idle or low workload periods while having the capability to boost performance during times of high computational requirements. A common method of managing the power consumption of an electronic device using DVS is to reduce the power consumption (voltage and frequency) of the CPU when the device is idle or running applications that have very low computational requirements. Examples of applications having very low computational requirements are applications such as word processors, spreadsheets, email programs, and database programs. These are generally text-based programs into which data is input sequentially letter by letter. Even if the processor speed is lowered while working with such applications, the user will not notice any decrease in performance but will instead directly benefit from a much longer battery life. Conversely, highly computational programs such as media players or graphical video games involve large amounts of computations for each fraction of a second. While executing such programs, the user will notice the decrease in performance if the CPU frequency is lowered and, for some programs, if the frequency of the CPU is excessively low, the program will actually miss its timing requirements and fail to operate properly. To provide the required processing power, the CPU voltage and frequency must be raised when executing these computationally intense applications.

Application based power management is well known in the prior art and provides a method for managing the power consumption of an electronic device depending on the type of application being executed. However, with todays increased use of the world wide web (WWW) and portable society, people are increasingly using portable wireless devices to access resources on the Internet and view webpages having a variety of computation requirements. A need exists to reduce the power consumption of portable devices while surfing the Internet and viewing web pages.

### SUMMARY OF INVENTION

It is therefore a primary objective of the claimed invention to provide a method and apparatus for using the uniform/universal resource locator (URL) of a web page to manage the power consumption of a web browsing device, to solve the above-mentioned problem.

According to the claimed invention, a method is disclosed for managing the power consumption of a web browsing device when accessing a web page of a website. The web browsing device includes a CPU having a plurality of frequency or voltage settings. The method comprises: (a) Providing a prediction table listing predicted frequency or voltage settings of the CPU for a plurality of web pages. (b) If the address of the web page is listed in the prediction table, setting the frequency or voltage of the CPU to the predicted frequency or voltage setting for the web page listed in the prediction table, otherwise setting the frequency or voltage of the CPU to a default value. (c) Processing the web page with the CPU set to the predicted frequency or voltage setting.

Also according to the claimed invention, a portable web browsing device is disclosed comprising a CPU having a plurality of frequency or voltage settings, a storage device storing a prediction table listing predicted frequency or voltage settings of the CPU for a plurality of web pages, and a power manager. The power manager is used for setting the frequency or voltage of the CPU when opening a web page. If the address of the web page to be accessed is listed in the prediction table, the power manager sets the frequency or voltage of the CPU to the predicted frequency or voltage setting for the web page listed in the prediction table. If the address of the web page to be accessed is not listed in the prediction table, the power manager sets the frequency or voltage of the CPU to a default value.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a table of CPU voltages and frequencies for the Intel Mobile Pentium®III processor using Intel SpeedStep® Technology according to the prior art.

FIG. 2 is a flowchart describing a method of URL-based power management for managing the power consumption of a web browsing device when opening a web page according the present invention.

FIG. 3 is a block diagram of a web browsing device according to the present invention.

FIG. 4 is a first software architecture for the web browsing device of FIG. 3.

FIG. 5 is a second software architecture for the web browsing device of FIG. 3.

### DETAILED DESCRIPTION

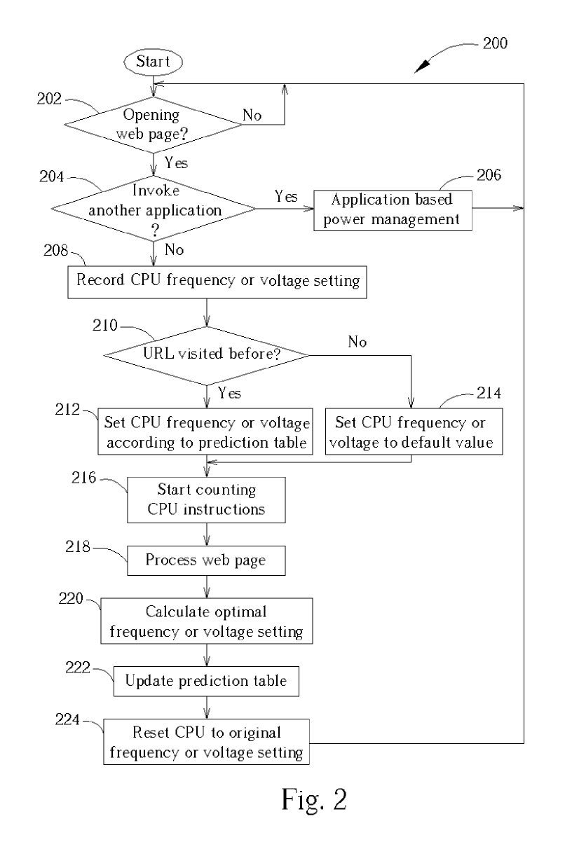

FIG. 2 shows a flowchart 200 describing a uniform/universal resource locator (URL) based power management method for managing the power consumption of a web browsing device when opening a web page according to the present invention. The present invention method is based on two principles. Firstly, due to habits and interests, users tend to repeatedly visit the same group of web pages. Secondly, the computing complexity of a given web page generally remains constant. Although the content of the web page may change, the structure and computing complexity is normally not affected. The web browsing device includes a CPU having a plurality of frequency or voltage settings such as a microprocessor capable of providing different DVS core frequencies and voltages. The web browsing device also includes a prediction table listing predicted frequency and voltage settings of the CPU for a plurality of web pages which have been visited recently. The predicted frequency or voltage settings in the predication table are listed according to web page URL address. As shown in FIG. 2, adjusting the frequency or voltage of the CPU according to the computing complexity of a particular web page contains the following steps:

Step 202: Is the web browsing device opening a web page? If yes then proceed to step 204, otherwise remain at step 202.

Step 204: Is the content of the web page capable of being processed by the web browser? In the preferred embodiment of the present invention, the frequency or voltage setting of the CPU is adjusted only on the condition that the webpage to be accessed contains content capable of being processed by the web browser of the web browsing device. Examples include: hyper text markup language (HTML) content, extensible markup language (XML) content, digital image data, portable document format (PDF) content, or video bitstreams being compliant to the web browser. For other types of web page content incapable of being processed by the web browser, such as word documents, another application is invoked to process the web page and the CPU has its frequency or voltage setting controlled by the prior art application based power manager. If the web page content is capable of being processed by the web browser then proceed to step 208, otherwise proceed to step 206.

Step 206: Activate application based power management. If required, send a message to the application power manager to specify the type of content being accessed by the new URL. As the application based power manager is well known in the prior art, further description of its operation is hereby omitted. Return to step 202 to wait for the next web page to be opened.

Step 208: Record the original frequency or voltage setting of the CPU as previously set by the application based power manager and proceed to step 210.

Step 210: Has this URL address been visited before? If the URL address is listed in the prediction table then proceed to step 212, otherwise proceed to step 214.

Step 212: Set the CPU frequency or voltage according to the predicted frequency or voltage setting listed in the prediction table. Proceed to step 216.

Step 214: Set the CPU frequency or voltage to a default value. For maximum power savings, set the CPU frequency or voltage setting to the lowest value. Alternatively, for maximum performance, set the CPU frequency or voltage setting to the highest value. Proceed to step 216.

Step 216: Start counting the CPU instructions. Determine the CPU workload while processing the web page by counting the number of CPU instructions needed to fully process the web page. Proceed to step 218.

Step 218: Process the web page. When the web page has been fully processed, proceed to step 220.

Step 220: Calculate an optimal frequency or voltage setting of the CPU for the web page. Given a user specified time period specifying the maximum allowable processing time for the web page, determine the lowest possible CPU frequency or voltage setting that still meets the user specified time value. This lowest possible frequency or voltage setting of the CPU is the optimal frequency or voltage setting of the CPU that uses the least amount of power, yet fully processes the web page in the user specified period thereby sufficiently meeting user demands. When calculated, proceed to step 222.

Step 222: Update the prediction table to reflect the optimal frequency or voltage setting of CPU calculated in step 220. Because the content of the web page may change slightly, a weighting formula can be used to combine the predicted frequency or voltage setting of the CPU listed in the predication table with the optimal frequency or voltage setting of the CPU calculated in step 220.

Step 224: Reset the CPU to the original frequency or voltage setting stored in step 208 and then proceed to step 202 to wait for the web browsing device to open the next web page.

To further explain step 220, consider a user specified time period of 100 ms. A user specified time period of 100 ms means that the entire web page should be processed in 100 ms. Please note, that 100 ms is an example value chosen because testing has shown that users can tolerate a 100 ms delay for interactive applications. However, this specific time period value can be changed and is by no way limited to 100 ms. Assuming each instruction is executed in a single clock cycle, to calculate the optimal frequency or voltage setting of the CPU, first calculate the optimal frequency of the CPU based on the user specified time period using the following formula:

Freq._{OPT}=(Instruction Count of this web page)/(user specified time period) In this example, assume a total of 47 million instructions are required to fully process the web page. Using the above formula with a user specified time period of 100 ms, this equates to an optimal frequency of Freq._{OPT}=470 MHz.

When updating the prediction table in step 222, a weighted frequency reflecting both the optimal frequency calculated in step 220 and the predicted frequency from the predicted frequency or voltage setting stored in prediction table can be used. The following weighting formula can be used to calculated the weighted frequency:

Freq._{WEIGHTED}=α×Freq._{TABLE}+(1α)×Freq._{OPTIMAL} The symbol α in the above formula represents a percentage of how strong the prediction table history is compared to the optimal value. Continuing the example, assume the prediction table already stores a predicted frequency of 700 MHz for the current web page and an α value of 80% (α=is used. These values equate to a weighted frequency of Freq._{WEIGHTED}=654 MHz, which is then stored in the prediction table.

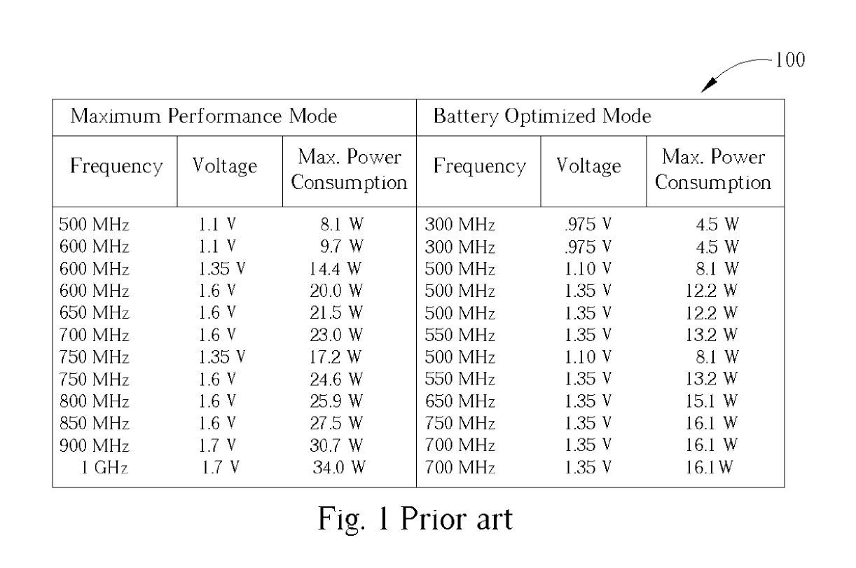

It should also be noted that when setting the CPU frequency or voltage in step 212, it may not be possible to directly set the frequency of the CPU to the frequency stored in the prediction table. For example, assuming a CPU using the same DVS core frequency and voltage options as listed in FIG. 1, if the predicted frequency setting of the CPU stored in the prediction table is 654 MHz, a frequency of 700 MHz and a voltage of 1.35V is the lowest power-related setting of the CPU that still allows the user specified time period constraint to be met. Alternatively, if the predicted frequency setting stored in the prediction table is 644 MHz, a frequency of 650 MHz and a voltage of 1.35V can be used and will still fully process the web page in the user specified time period.

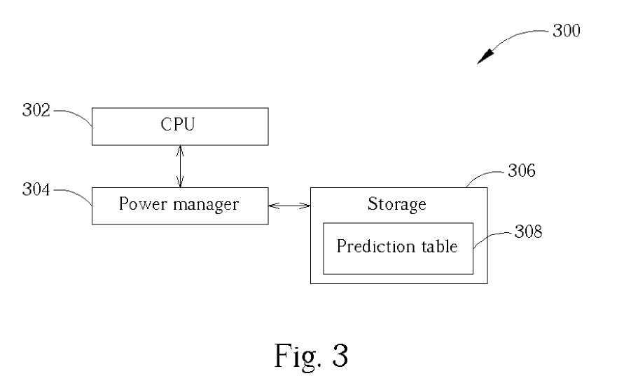

FIG. 3 shows a block diagram of a web browsing device 300 according to the present invention. The web browsing device 300 includes a CPU 302, a power manager 304, a storage device 306, and prediction table 308 stored in the storage device 306. The CPU 302 supports a plurality of frequency or voltage settings implemented using DVS, and the prediction table 308 contains predicted DVS frequency or voltage settings for a plurality of web pages indexed by the web page universal/uniform resource locator (URL) address.

Following the flowchart of FIG. 2, the web browsing device 300 operations are summarized as follows. When the web browsing device is directed to a new web page having content capable of being processed by the web browser, for example HTML content, the power manager 304 records the original frequency or voltage setting of the CPU 302 and then adjusts the frequency or voltage setting of the CPU 302 to the predicted frequency or voltage setting of the CPU 302 for the web page listed in the prediction table. As specified above, if the predicted frequency or voltage setting stored in the prediction table is not one of the available DVS options of the CPU 302, the power manager rounds the predicted frequency or voltage setting up to the next available DVS option of the CPU. Additionally, if the web page URL address is not listed in the prediction table, the power manager sets the frequency or voltage setting of the CPU to a default value representing a default level. Depending on user requirements, the default level can be either maximum performance, maximum power conservation, or a compromise between the two. While processing the web page, the power manager counts the number of CPU instructions from the start of the web page processing to the end of web page processing. The total number of CPU instructions is used to determine the optimal frequency or voltage setting of the CPU that allows the CPU to fully process the web page in a user specified time period, and the prediction table is updated to reflect this optimal frequency and voltage setting of the CPU. Finally, the CPU is returned to the original frequency and voltage setting as previously specified by the application based power manager.

The power manager 304 can be implemented as a hardware component or a software component. If implemented in software, two types of software architectures can be used, the first comprising the power manager running as an independent application, the second comprising integrating the power manager as a part of the operating system.

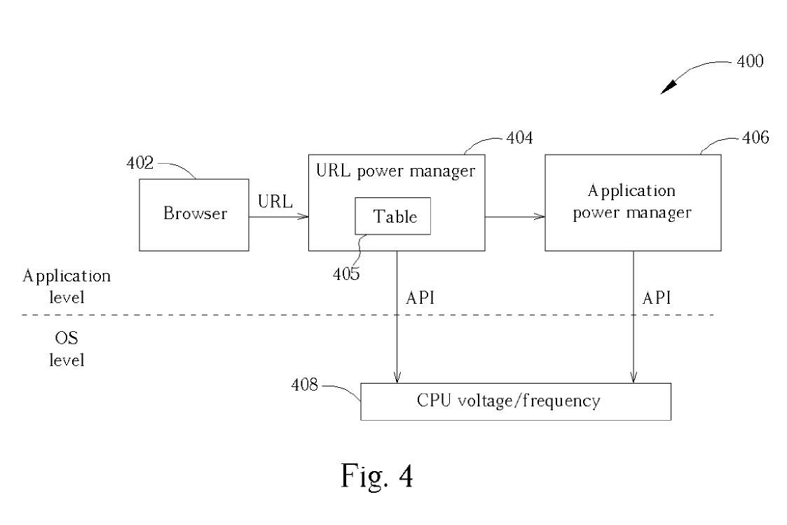

FIG. 4 shows a first software architecture 400 for the web browsing device 300 of FIG. 3. The first software architecture 400 contains two software levels: the application level and the operating system (OS) level. The application level comprises a browser application 402, a URL based power manager 404, and an application based power manager 406. The application based power manager 406 adjusts the frequency or voltage setting of the CPU according to the type of the application software being executed. When opening a new web page, the browser 402 sends the URL of the web page to the URL power manager 404. If the content of the web page is capable of being processed by the web browser, for example HTML content, the URL power manager uses the prediction table 405 to determine the predicted frequency or voltage setting of the CPU for the web page. An application program interface (API) is used to instruct the operating system to modify the CPU and voltage frequency 408. If the web page contains content that is incapable of being processed by the web browser, the URL power manager 404 transfers control for power management to the application based power manager 406.

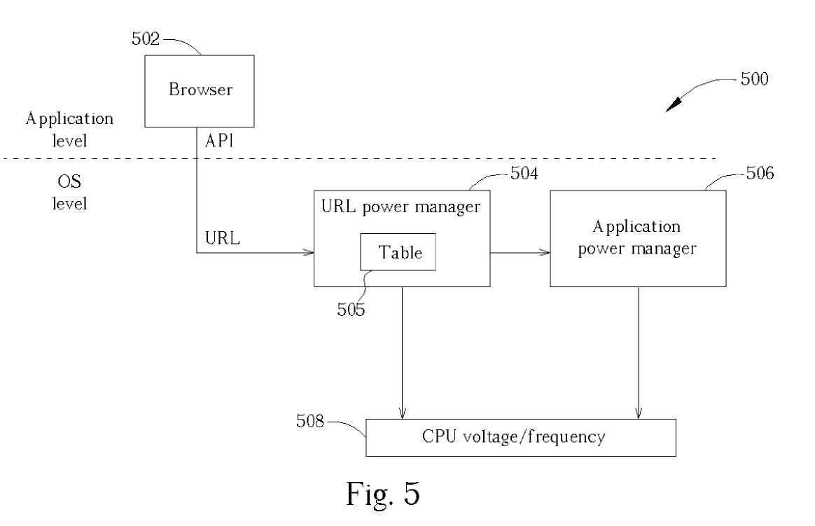

FIG. 5 shows a second software architecture 500 for the web browsing device 300 of FIG. 3. The second software architecture 500 also contains the application level and the OS level, however, the power management functions are integrated as a part of the operating system. In FIG. 5, the application level comprises a browser application 502, while the operating system level contains a URL based power manager function 504, and an application based power manager function 506. When the browser 502 opens a web page, the URL of the web page is received by the URL power manager function 504 through an API function call from the browser 502. If the content of the web page is capable of being processed by the web browser 502, for example HTML content, the URL power manager 504 uses the prediction table 505 to determine the predicted frequency or voltage setting of the CPU for the web page and the CPU voltage and frequency 508 are directly modified. If the web page contains content incapable of being processed by the web browser 502, the URL power manager function 504 allows the application power manager function 506 to control the frequency or voltage settings of the CPU.

Although the preferred embodiment described throughout this detailed description involves determining the CPU frequency or voltage according to predicted frequency or voltage settings stored in a prediction table and indexed by URL addresses of web page distributed across the Internet, other embodiments are also possible. For example, other types of addresses, such as IP address, could be used to index the prediction table. Additionally, different types of web pages not necessarily distributed across a network could be accessed and processed. An example of this alternative embodiment is a portable device accessing and processing files stored on a local hard drive, and using the directories and filenames as the addresses of the files in the prediction table. The predicted frequency or voltage settings stored in the prediction table specify the lowest possible CPU frequency or voltage that allows each file to be fully processed in the user specified time period.

In contrast to the prior art, the present invention manages the power consumption of a web browsing device, more precisely a portable device, using the address of a web page to index a prediction table listing predicted frequency or voltage settings of the CPU for a plurality of web pages. By tracking the CPU workload required to fully process the web page, an optimal frequency or voltage setting can be calculated and the prediction table can be updated to reflect the optimal frequency or voltage setting. In this way, the power consumption of the portable device is minimized while still allowing the web page to be fully processed in a user specified time period.

Those skilled in the art will readily observe that numerous modifications and alterations of the device may be made while retaining the teachings of the invention. Accordingly, that above disclosure should be construed as limited only by the metes and bounds of the appended claims.

1. A method of managing the power consumption of a web browsing device when accessing a web page, the web browsing device including a CPU having a plurality of frequency or voltage settings, the method comprising:
(a) providing a prediction table listing predicted frequency or voltage settings of the CPU for a plurality of web pages;
(b) if the address of the web page is listed in the prediction table, setting the frequency or voltage of the CPU to the predicted frequency or voltage setting of the CPU for the web page listed in the prediction table, otherwise setting the frequency or voltage of the CPU to a default value; and
(c) processing the web page with the CPU set to the predicted frequency or voltage setting.

2. The method of claim 1, further comprising storing the original frequency or voltage setting of the CPU, and after processing the web page with the CPU set to the predicted frequency or voltage setting, setting the frequency or voltage of the CPU to the original frequency or voltage setting.

3. The method of claim 1, further comprising:
(d) tracking the CPU workload during the processing of the web page;
(e) calculating an optimal frequency or voltage setting for the CPU based on the CPU workload during the processing of the web page; and
(f) updating the prediction table to reflect the optimal frequency or voltage setting for the web page.

4. The method of claim 3, wherein tracking the CPU workload during the processing of the web page comprises counting the CPU instructions from the start of the web page processing to the end of the web page processing.

5. The method of claim 3, wherein calculating the optimal frequency or voltage setting for the CPU comprises calculating the lowest frequency or voltage setting for the CPU that still allows the CPU to fully process the web page in a predetermined time period.

6. The method of claim 3, wherein when updating the predication table to reflect the optimal frequency or voltage setting of the CPU for the web page, the method comprises taking into account the predicted frequency or voltage setting of CPU listed in the predication table, wherein the predicted frequency or voltage setting takes into account the history of frequency or voltage settings for the web page and is combined with the optimal frequency or voltage setting using a weighting formula.

7. The method of claim 1, wherein setting the frequency or voltage setting of the CPU involves changing the CPU core voltage and frequency.

8. The method of claim 1, wherein the web browsing device is a portable device and the web page contains hyper text markup language (HTML) content, digital image data, extensible markup language (XML) content, portable document format (PDF) content, or a video bitstream capable of being directly processed by a web browser of the web-browsing device.

9. A web browsing device comprising:
a CPU having a plurality of frequency or voltage settings;
a storage device storing a prediction table listing predicted frequency or voltage settings for a plurality of web pages; and
a power manager for setting the frequency or voltage setting of the CPU when accessing a web page, wherein if the address of the web page is listed in the prediction table, the power manager sets the frequency or voltage of the CPU to the predicted frequency or voltage setting for the web page listed in the prediction table, and if the address of the web page is not listed in the prediction table, the power manager sets the frequency or voltage of the CPU to a default value.

10. The web browsing device of claim 9, wherein the power manager first stores the original frequency or voltage setting of the CPU, and after the CPU processes the web page with the CPU set to the predicted frequency or voltage setting, the power manager sets the frequency or voltage setting of the CPU to the original frequency or voltage setting.

11. The web browsing device of claim 9, wherein the power manager further tracks the CPU workload during the processing of the web page, calculates an optimal frequency or voltage setting for the CPU based on the CPU workload during the processing of the web page, and updates the prediction table to reflect the optimal frequency or voltage setting of the CPU for the web page.

12. The web browsing device of claim 11, wherein when tracking the CPU workload during the processing of the web page, the power manager counts the CPU instructions from the start of the web page processing to the end of the web page processing.

13. The web browsing device of claim 11, wherein when calculating an optimal frequency or voltage setting for the CPU, the power manager calculates the lowest frequency or voltage setting for the CPU that still allows the CPU to fully process the web page in a predetermined time period.

14. The web browsing device of claim 11, wherein when updating the predication table to reflect the optimal frequency or voltage setting for the web page, the power manager takes into account the predicted frequency or voltage setting listed in the predication table, wherein the predicted frequency or voltage setting takes into account the history of frequency or voltage settings for the web page and is combined with the optimal frequency or voltage setting using a weighting formula.

15. The web browsing device of claim 9, wherein the plurality of frequency or voltage settings of the CPU comprises a plurality of CPU core voltage and frequency settings.

16. The web browsing device of claim 9, wherein the web browsing device is a portable device and the web page contains hyper text markup language (HTML) content, extensible markup language (XML) content, digital image data, portable document format (PDF) content, or a video bitstream capable of being directly processed by a web browser of the web browsing device.
